(19) United States
(12) Patent Application Publication
(10) Pub. No.: US 2010/0277799 A1
(43) Pub. Date: Nov. 4, 2010

(54) ADJUSTABLE OPTICAL SUPPORT

(75) Inventors: Roman Steffen, Rebstein (CH); Thomas Oehy, Diepoldsau (CH); Hanspeter Nuesch, Eschen (CH)

Correspondence Address: CROWELL & MORING LLP;INTELLECTUAL PROPERTY GROUP, P.O. BOX 14300, WASHINGTON, DC, 20044-4300, US

(73) Assignee: Hilti Aktiengesellschaft, Schaan (LI)

(21) Appl. No.: 12/770,433

(22) Filed: Apr. 29, 2010

(30) Foreign Application Priority Data
Apr. 30, 2009 (DE) 10 2009 002 779.3

(51) Int. Cl. G02B 7/00

(52) U.S. Cl. 359/503

(57) ABSTRACT

An optical support is disclosed. The optical support has at least two partial supports, each of which secure an optical component and are connected to each other by at least two connecting elements that are spaced apart planarly. The connecting elements are frictionally connected displaceable in an axial direction in matching associated connection openings via contact surfaces. The connecting elements and/or the connection openings have at least one recess in the contact surface.

This application claims the priority of German Patent Document No. 10 2009 002 779.3, filed Apr. 30, 2009, the disclosure of which is expressly incorporated by reference herein.

### BACKGROUND AND SUMMARY OF THE INVENTION

The present invention relates to an optical support having at least two partial supports, each of which secure an optical component and are connected to each other by at least two connecting elements that are spaced apart planarly, wherein the connecting elements are frictionally connected displaceable in an axial direction in matching associated connection openings via contact surfaces.

Laser diodes require collimator optics, which must be adjusted to the laser diode, for the parallelization of an emergent laser beam. During assembly first the laser diode and the collimator optics are mounted in an optical holder, designated as a partial support in the following, and then the mutual position of the laser diode and the collimator optics is adjusted.

According to German Patent Document No. DE 10 2006 000 343 B3, an optical assembly has an optical support that can be adjusted with respect to one axis, with which two optical components, e.g., laser diode and collimator optics, are firmly connected. The optical support is comprised of at least two partial supports, each securing an optical component. The two partial supports are connected to one another by at least three flexible, axially elongated connecting elements that are spaced apart planarly, wherein the connecting elements are frictionally fastened in an axially displaceable manner in matching associated connection openings. The connecting elements and the associated matching connection openings are arranged on the axial face surfaces of the partial supports and are preferably configured to be conical or cylindrical.

The disadvantage of the known optical assembly is that the connecting elements and the connection openings must be manufactured very precisely in order for the two partial supports to be connected. Because the connecting elements rest over the full area in the connection openings, high surface pressure forces develop, which produce the stick-slip effect. The stick-slip effect refers to the stick-slip gliding of solid bodies that are moved against one another; it leads to a rapid cycle of adhesion, distortion, separation and deterioration.

The stick-slip effect causes problems in the assembly and alignment of the optical assembly. In order to fasten the first and second optical component, the connecting elements of the first partial support are adjusted in the associated connection openings of the second partial support.

The action of a defined force in the region of a connecting element is supposed to precisely adjust the first and second optical component with each another. The stick-slip effect causes the connecting element not to move at first despite the action of the force and adhere to the connection opening. If the force is increased, the connecting element disengages from the connection opening and moves beyond the desired position in the connection opening. Because a force cannot act on the partial support in the reverse direction, the connecting element's change in position is irreversible. To some extent, the error can be compensated for by the fact that the other connecting elements are moved by the action of the force into the associated connection openings by the same distance. If the connecting element's change in position is too great or if a stick-slip effect also occurs in one of the other connecting elements, the optical support will be ruined.

In contrast, the object of the present invention is to further develop the known optical support to the effect that the connecting elements and the associated connection openings are pressed together in a simpler way.

This object is attained with an optical support in accordance with the invention in that the connecting elements and/or the connection openings have at least one recess in a contact surface. Because of the at least one recess, the contact surface and associated surface pressure that develops between the connecting element and the associated connection opening is reduced.

In a preferred embodiment, the at least one recess is configured as a slot running in the axial direction. It is especially preferred if the at least one slot running in the axial direction extends over the entire height of the connecting element and/or the connection opening in the axial direction.

In another preferred embodiment, the connecting elements and/or the associated connection openings have at least two slots running symmetrically in the axial direction and distributed over the circumference of the contact surface. The advantage of a symmetrical arrangement of the axial slots is that the force is transmitted uniformly and the distribution of stress is constant.

It is especially preferred, in the case of a rectangular cross-sectional surface, if the connecting elements and/or the associated connection openings have an even number of recesses, which are distributed symmetrically over the circumference of the contact surface.

In another preferred embodiment, the at least one recess runs along a helical line or is configured as a slot running in a radial direction.

It is especially preferred if the partial support and the connecting elements are configured to be one piece. The advantage of the embodiment of the partial support and the connecting elements as one piece is that there are no temperature effects on the contact surfaces.

In a preferred embodiment, the connecting elements have a transition area on an end facing away from the partial support. In another preferred embodiment, the connection openings have a first transition area and/or a second transition area.

Other advantages and advantageous embodiments of the subject of the invention can be found in the description and the drawings. Similarly, the characteristics cited in the foregoing and those listed below according to the invention, can respectively be used individually or multiply in any combinations. The embodiments that are shown and described should not be understood as an exhaustive enumeration, rather they have an exemplary character in describing the invention.

### BRIEF DESCRIPTION OF THE DRAWINGS

FIG. 1 illustrates an optical support in accordance with the invention having a first and a second partial support, which are connected via three connecting elements and three associated connection openings;

FIG. 2 illustrates a cylindrical connecting element and an associated cylindrical connection opening of the first and the second partial supports from FIG. 1 in the adjusted state, wherein the connection opening is configured as a stepped hole with a first and a second cylinder section;

FIG. 3 illustrates a cylindrical connecting element with four recesses arranged symmetrically in the axial direction and a cylindrical connection opening in the adjusted state;

FIGS. 4a and 4b illustrate a cylindrical connecting element with a helical recess (FIG. 4a) and a cylindrical connection opening (FIG. 4b) in the unadjusted state; and

FIGS. 5a and 5b illustrate a square connecting element having four axial recesses in a cross section perpendicular to the axial direction, wherein the recesses are arranged in the center of the sides of the square (FIG. 5a) and in the corners of the square (FIG. 5b).

### DETAILED DESCRIPTION OF THE DRAWINGS

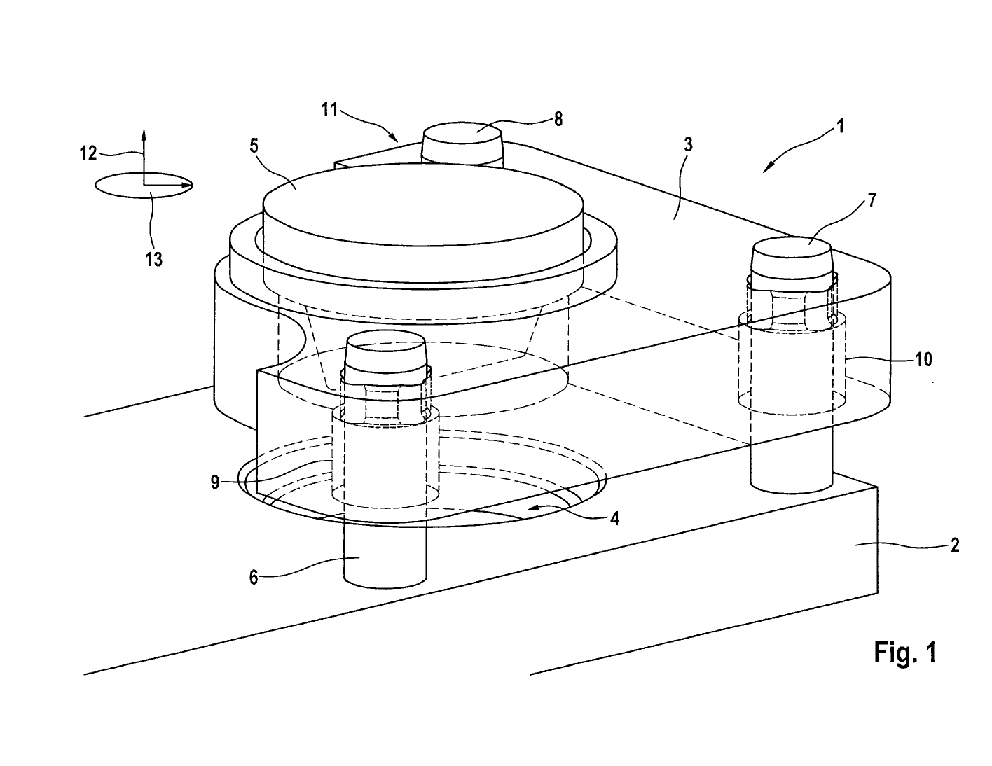

FIG. 1 shows an optical support 1 according to the invention having a first and second partial support 2, 3, each of which secure an optical component 4, 5. The first partial support 2 has three connecting elements 6, 7, 8 that are spaced apart planarly and the second partial support 3 has three connection openings 9, 10, 11 associated with the connecting elements 6-8. In order to adjust the first and second optical components 4, 5 with one another and to secure the adjusted state, the connecting elements 6-8 of the first partial support 2 are adjusted in the associated connection openings 9-11 of the second partial support 3. The securing is accomplished by frictional force between the contact surfaces of the connecting elements 6-8 and the contact surfaces of the connection openings 9-11. The contact surfaces are defined as the areas of the connecting elements and the associated connection openings that are in contact because of frictional force. The state in which the connecting elements are adjusted in the connection openings is designated as the adjusted state.

The connecting elements 6-8 are made of a flexible material. On their lower ends, the connecting elements 6-8 are connected to the first partial support 2. The first partial support 2 and the connecting elements 6-8 are configured as one piece in the design shown in FIG. 1. As an alternative, the first partial support 2 and the connecting elements 6-8 can be configured as several pieces. The advantage of the one-piece design over the several-piece design is that the component can be manufactured in a clamping operation (required in order to comply with the required positional accuracy) and that no temperature effects develop on the contact surfaces of the joined parts.

In the embodiment depicted in FIG. 1, the connecting elements 6-8 and the associated connection openings 9-11 are configured to be cylindrical. Alternatively, the connecting elements of the first partial support 2 and the connection openings of the second partial support 3 can have a rectangular or square cross-sectional surface. Cross-sectional surfaces with a symmetry in an axial direction (arrow 12) are preferably used, which in addition can be manufactured simply, precisely and cost-effectively. The advantage of symmetrical cross-sectional surfaces is that the force or distribution of stress is uniform. The axial direction 12 is defined as the direction in which the connecting elements 6-8 of the first partial support 2 are aligned. The radial direction is defined as the plane 13 perpendicular to the axial direction 12.

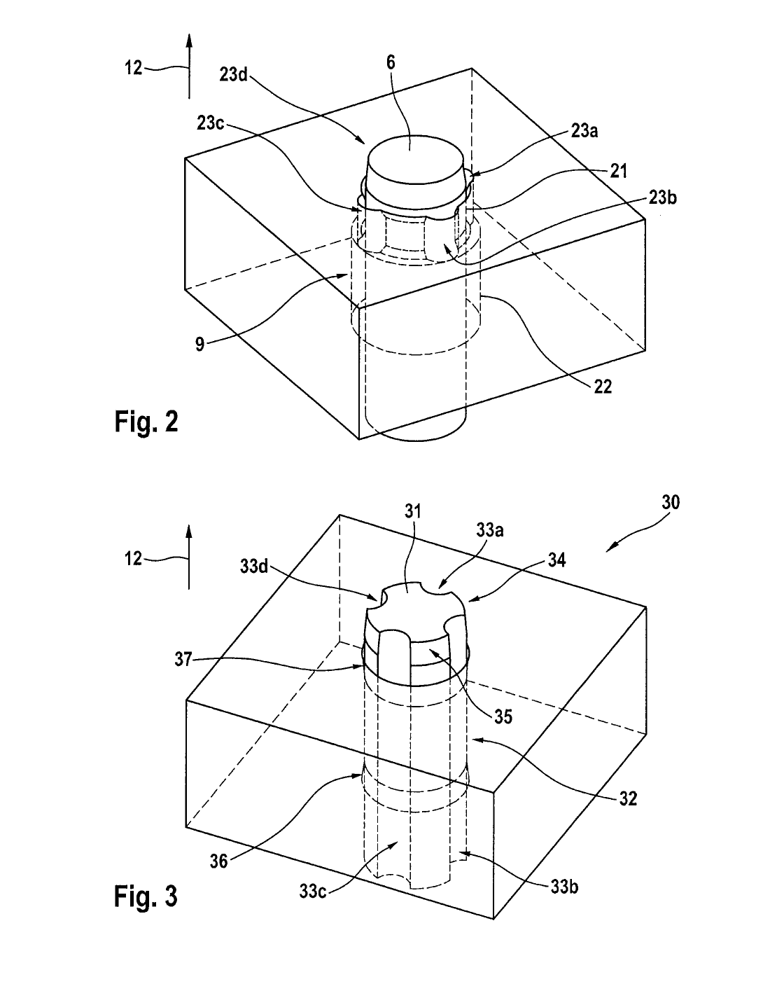

FIG. 2 shows an enlarged representation of the cylindrical connecting element 6 of the first partial support 2 and the associated connection opening 9 of the second partial support 3 of the optical support 1 from FIG. 1 in the adjusted state. The cylindrical connection opening 9 is configured as a stepped hole with a first cylinder section 21 and a second cylinder section 22. The diameter of the first cylinder section 21 is adjusted to the diameter of the connecting element 6 in such a way that the first cylinder section 21 and the connecting element 6 form a clearance fit in the connected state. The second cylinder section 22 and the connecting element 6 are not in contact with one another in the adjusted state.

The second cylinder section 22 represents a radial slot running in the radial direction 13, which is designated as the radial slot. In order to reduce the surface pressure, several radial slots arranged in the axial direction 12 can be arranged in the connecting element or in the associated connection opening, wherein the number and width of the radial slots are adjusted to the surface pressure forces that occur. The radial slots can run in the radial direction over the full circumference of the connecting element or the connection opening or they can be configured in an interrupted manner. The advantage of a symmetrical embodiment of the radial slot in the radial direction 13 along the contact surface is that the force is transmitted uniformly and the distribution of stress is constant.

In order to reduce the surface pressure occurring between the first cylinder section 21 and the connecting element 6, four slot-shaped recesses 23a-23d that run in the axial direction 12 and are designated as axial slots, are arranged in the first cylinder section 21. The four axial slots 23a-23d are arranged symmetrically on the circumference of the first cylinder section 21. The advantage of the symmetrical arrangement of the axial slots 23a-23d is that the force is transmitted uniformly and the distribution of stress is constant.

The shape of an axial slot is determined by the length in the axial direction 12 and the cross-sectional surface in the radial direction 13 perpendicular to the axial direction 12. The cross-sectional surface of the axial slot is selected in such a way that the axial slot can be manufactured simply and cost-effectively, for example by milling.

FIG. 2 shows the combination of a radial slot 22 with several axial slots 23a-23d, wherein the radial slot 22 and the axial slots 23a-23d are arranged in cylinder sections 21, 22 of the connection opening 9 that are displaced in the axial direction 12. Axial and radial slots may also be arranged in the same section of the connecting element or of the connection opening and intersect. In addition, axial and/or radial slots may be combined with other recesses, e.g., helical recesses.

FIG. 3 shows a section of another embodiment of an optical support 30 in accordance with the invention having a cylindrical connecting element 31 and an associated cylindrical connection opening 32 in the adjusted state. The cylindrical connecting element 31 has four slots 33a-33d distributed symmetrically on the circumference and running in the axial direction 12. The optical support 30 differs from the embodiment in FIG. 2 in that the recesses in the shape of axial slots 33a-33d are arranged in the connecting element of the first partial support and not as in FIG. 2 in the connection opening of the second partial support.

The axial slots 33a-33d run in the axial direction 12 over the entire height of the connecting element 31. Alternatively, the height of the axial slots 33a-33d could be limited to the height of the contact surface of the connecting element 31 with the connection opening 32 or to a portion of the height of this contact surface. The embodiment depicted in FIG. 3 with axial slots 33a-33d, which run over the entire height of the connecting element 31, can be manufactured by milling more simply than axial slots which only run over a limited height of the connecting elements.

In order to be able to adjust the connecting element 31 during assembly in the connection opening 32 more simply, the connecting element 31 has a transition area 35 with a reduced diameter on an end opposing the partial support.

The cylindrical connection opening 32 has a first transition area 36 and a second transition area 37 on two opposing ends. Like transition area 35 of the connecting element 31, the first transition area 36 allows the connecting element 31 to be adjusted more easily in the connection opening 32. The second transition area 37 of connection opening 32 serves to thereby secure the connecting element 31 in the position where the material can expand.

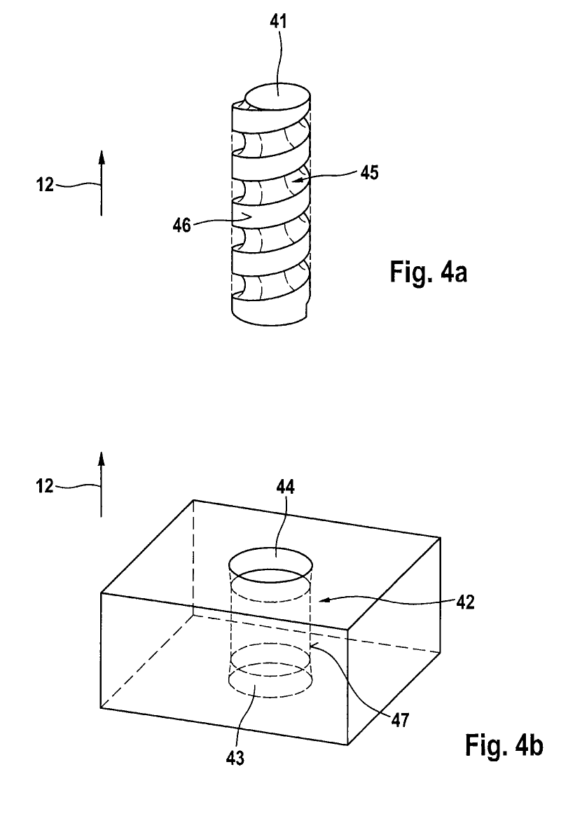

FIGS. 4a and 4b show a further embodiment of a connecting element 41 (FIG. 4a) in accordance with the invention and an associated connection opening 42 (FIG. 4b) in the unadjusted state. The connecting element 41 and the associated connection opening 42 are configured to be cylindrical. The connection opening 42 is configured in a manner analogous to the connection opening 32 of FIG. 3 with a first and second transition area 43, 44. Arranged in the outer cylindrical surface of the connecting element 41, i.e., in the contact surface with the connection opening 42, is a helically configured recess 45. The remaining helical outer surface 46 of the connecting element 41 is in contact with the cylindrical inner surface 47 of the connection opening 42 in the adjusted state.

The pitch and width of the helical line are selected in such a way that the contact surface of the connecting element 41 with the associated connection opening 42 is reduced by the desired portion and the recess 45 is simple to manufacture on the other hand. The helically configured recess 45 can be combined with recesses which run in the axial direction 12.

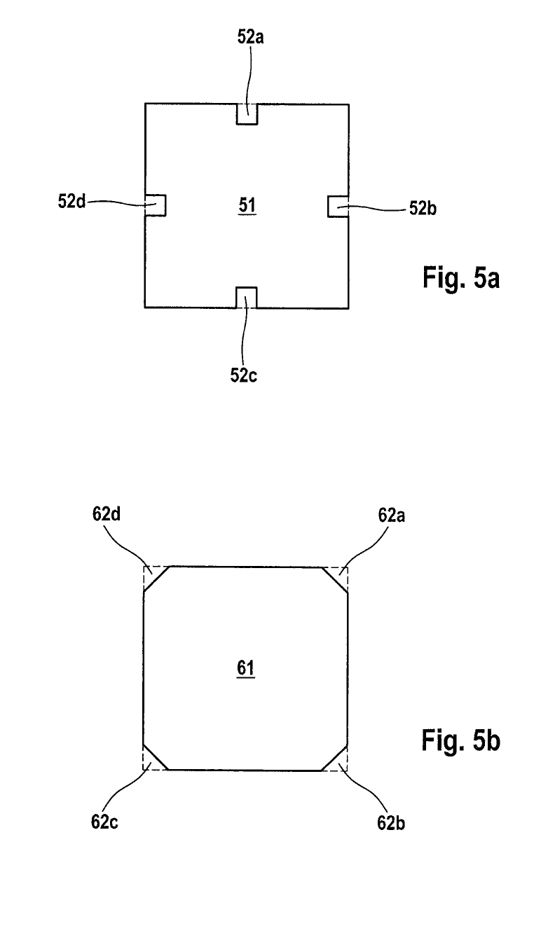

FIGS. 5a and 5b show additional embodiments of connecting elements 51, 61 in accordance with the invention having a square cross-sectional surface with four axial slots in a cross section perpendicular to the axial direction 12.

FIG. 5a depicts a square connecting element 51 with four axial slots 52a-52d, which are distributed symmetrically on the circumference of the connecting element 51. The axial slots 52a-52d are arranged respectively in the center of the four sides of the square of the connecting element 51 and are configured to be rectangular.

FIG. 5b depicts a square connecting element 61 with four axial slots 62a-62d, which are distributed symmetrically on the circumference of the connecting element 61. The axial slots 62a-62d are arranged respectively in the four corners of the square of the connecting element 61 and are configured to be triangular.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An optical support, comprising:
at least two partial supports, wherein in each of the at least two partial supports a respective optical component is securable; and
at least two connecting elements that are spaced apart planarly and are included on a first of the at least two partial supports and wherein the at least two connecting elements each define a first contact surface;
wherein a second of the at least two partial supports defines at least two connection openings and wherein the at least two connection openings each define a second contact surface;
wherein the at least two connecting elements are respectively frictionally connectable and displaceable in an axial direction in the at least two connection openings via the first and second contact surfaces;
and wherein the first contact surface of the at least two connecting elements and/or the second contact surface of the at least two connection openings have at least one recess.

2. The optical support according to claim 1, wherein the at least one recess is configured as a slot running in the axial direction.

3. The optical support according to claim 2, wherein the at least one slot running in the axial direction extends over an entire height of the at least two connecting elements and/or the at least two connection openings in the axial direction.

4. The optical support according to claim 1, wherein the first contact surface of the at least two connecting elements and/or the second contact surface of the at least two connection openings have at least two recesses configured as slots running in the axial direction and wherein the at least two recesses run symmetrically in the axial direction and are distributed over a circumference of the respective contact surface.

5. The optical support according to claim 1, wherein the at least two connecting elements and the at least two connection openings have a rectangular cross-section, and wherein the at least two connecting elements and/or the at least two connection openings have an even number of recesses which are distributed symmetrically over a circumference of the respective contact surface.

6. The optical support according to claim 1, wherein the at least one recess runs along a helical line.

7. The optical support according to claim 1, wherein the at least one recess is configured as a slot running in a radial direction.

8. The optical support according to claim 1, wherein the first of the at least two partial supports and the at least two connecting elements are configured to be one piece.

9. The optical support according to claim 1, wherein the at least two connecting elements have a transition area on an end facing away from the first of the at least two partial supports.

10. The optical support according to claim 1 wherein the at least two connection openings have a first transition area and/or a second transition area.
